(19) United States
(12) Patent Application Publication
(10) Pub. No.: US 2005/0097808 A1
(43) Pub. Date: May 12, 2005

(54) Humane tubular trap, remote trap monitoring system and method and programs for monitoring multiple traps

(76) Inventors: James Frederick Vorhies, Sequim, WA (US); James Francis Vorhies, Sequim, WA (US); William E. Carter JR., Sequim, WA (US)

Correspondence Address: Jacques M. Dulin, Esq.;Innovation Law Group, Ltd., NetPort Center, Suite 201, 224 W. Washington Street, Sequim, WA, 98382-3338, US

(21) Appl. No.: 10/940,864

(22) Filed: Sep. 13, 2004

Related U.S. Application Data
(60) Provisional application No. 60/502,430, filed on Sep. 12, 2003.
(60) Provisional application No. 60/509,881, filed on Oct. 8, 2003.

(51) Int. Cl. A01M 23/16; A01M 23/18; A01M 23/20

(52) U.S. Cl. 43/61; 43/58

(57) ABSTRACT

Tube-type animal trap systems for the humane non-injurious, non-invasive trapping of animals, and to methods and systems for electronic remote trap monitoring and management. The invention includes mechanical and electric/electronic, tube-type traps, and to electronic data communications systems that enable remote monitoring of the status of any type of trap (e.g., is the trap tripped or not). Computer systems at a remote home base permit simultaneous management of multiple traps in the field, including enabling management via the Internet.

### CROSS REFERENCE TO RELATED APPLICATIONS

This application is the Regular U.S. Application related to and based on Provisional Application Ser. No. 60/502,430 filed Sept. 12, 2003 under the title Tubular Trap, and on Provisional Application Ser. No. 60/509,881 filed Oct. 8, 2003, entitled Tubular Trap II, both filed by two of the same inventors (the Vorhies), the priorities of which applications are claimed under 35 US Code §§ 119 and 120, the entire subject matter of which applications are hereby incorporated by reference.

### FIELD

The invention pertains to the trapping industry, and more particularly to humane animal tube-type or tunnel-type trap systems for the non-injurious, non-invasive trapping of animals, and to methods and systems for electronic remote trap monitoring and management. The invention includes mechanical and electric/electronic, humane, tube-type traps, and to electronic data communications systems that enable remote monitoring of the status of any type of trap (e.g., is the trap tripped or not).

### BACKGROUND

The trapping industry is essential, economically important, controversial, and highly regulated. Trapping activities have several purposes, including wildlife management, (population control or relocation), nuisance elimination (pest control) by killing or removal, and fur pelt harvesting. Trappers must follow strict rules established and enforced by the state fish and wildlife agencies.

There are a wide variety of traps that have been home-made or commercially available for hundreds of years. Most familiar are mechanically powered killing traps (e.g. rat trap), live-hold leg or body gripping traps, and cage type traps or snares. Many are cruel in well documented ways. The Humane Society of America states that the leg hold trap is still the most widely used trap in the United States even though 74% of Americans oppose its use, and its banning by at least eight states and four cities.

The Fur Institute of Canada has established a research program to develop humane trapping systems for specified fur-bearers. Its program has included development of humane killing traps, and live hold trapping systems that minimize animal injury. Live hold traps include “soft” hold traps and cage traps.

Research for the Fur Institute by the University of Minnesota “supports the need to visit live-hold trapping systems as early in the morning as possible, as recommended in trappers' manuals.” (DNR Nova Scotia, Conservation, v.11 No.4 1987). The National Trappers Association also recognizes that traps must be checked once per calendar day. (nationaltrappers.com).

The International Association of Fish and Wildlife Agencies conducts a program to issue Best Management Practices for conduct of trapping activities. It is an organization of public agencies charged with the protection of North America's wildlife resources. The 50 state fish and wildlife agencies as well as the provincial and territorial governments in Canada are members. “The ultimate objective is to have economical trapping systems that are safe, practical, selective, efficient, and address the welfare of trapped animals.”

As an indication of the volume of trapping activity, the 2002-2003 Wisconsin Furbearer Status Report states that the trapping harvest of 13 species of animals was 644,420, while the hunting harvest of five species was 243,910. (The most trapped species were muskrat, raccoon, and beaver, followed distantly by mink and opossum.) The total value of harvested pelts was $6,547,293.

While these Furbearer reports do not indicate the number of days that trapping is allowed, the annual daily average trapping harvest is 1765 per day. If every trap harvests an animal every day, then there are at least 1765 traps per day that must be visited every morning in Wisconsin. But if the harvest rate is only 50%, the number of traps to be checked every day is 3530. That is, operating a trapping business requires a lot of early morning trap checking, and depending on the geographic locations and the weather, man-aging trap lines is time consuming, and can be difficult, involving as it does a lot of travel and outdoor activity.

A common type of non-injurious trap is the so-called “Havaheart” brand cage-type traps that employ spring loaded sheet metal or wire screen doors leading into a wire cage.

A small, body-grip type trap for red squirrels, chipmunks and rats employs a 3½″ diameter plastic tube having a spring loaded pair of bars (the “jaws”) in the middle. When the animal takes the bait on a plate-type trigger that is located between the bars, the animal is trapped between the bars and the inner wall of the tube. The animal is typically crushed, killing it.

The trapping and hunting trade also employs tubular cages of wire mesh for train-ing hunting dogs. A captured, live raccoon is placed in the cage that has a diameter on the order of 18″ to 2′. The coon's activity makes the cage roll, and that gets the attention of puppies that chase the cage.

With the growth and encroachment of housing and commercial development into the habitats of wild animals, and the increasing numbers of feral cats and dogs, the need for humane animal control is growing. However, animals are smart. For example, a wire cage-type trap may work on one animal, but others in the area, seeing and hearing the trapped animal, will avoid the area and that type of trap. The presence and attack activity of dogs, cats and other predators that come across the trapped animal may make it frantic and injure itself during unsuccessful attempts to flee, escape or defend itself.

Accordingly, there is an unmet need in the field for an improved, non-injurious, non-invasive, simple, light-weight, effective trap that can be used for small to medium-sized animals for humane management and control, as well as a more effective and efficient means of monitoring traps.

### THE INVENTION

### SUMMARY OF THE INVENTION, INCLUDING OBJECTS AND ADVANTAGES

The invention comprises a humane, non-invasive, non-injurious animal trap comprising an opaque, substantially closed, tubular body having at least one door and either an electrical or mechanical trigger and door closure system for operation of the trap. In the best mode, a configurable trap data communications module unit is mounted either on, or connected to, each trap that is to be monitored and managed, in conjunction with a remote data communications home base. The trap data communication and management system includes data encoders, transmitters and/or transceivers, computer programs, and related equipment to enable activation, coding, decoding and use of the data communications system, including display and management and operation report generation.

The inventive trap comprises preferably a double walled, or alternatively a single walled, tubular animal trap, gravity-fall door(s) at one or both ends, an optional step-on trigger plate, and a mechanical or electrically actuated system or mechanism to release the door when actuated or activated by movement of the trigger plate or magnetically-sensed bait can movement.

The opaque, double walls and tubular configuration of the trap both attracts and calms the animals. The double walls provide insulation, preventing heat prostration and thermal distress to the animal. In many States, it is illegal to use meat for bait that is visible to birds of prey. Thus, the opaque tube prevents the bait from being visible, and protects the bait from weather.

The tubular configuration is evocative of a den or burrow, and the opaque walls preserve a noc-turnal (no light or low light) environment that is familiar to, and therefore comfortable for, the animals trapped. Further, since the walls are opaque, once the animal is trapped, it feels safer, in that any predators that happen by cannot see the animal and there is a reduction, to the point of essential elimination, of animal self-injury in the trap due to predator interference provoking frantic attempts to escape. In addition, the smooth, almost slippery, plastic inner wall of the traps does not provide any purchase for the animal to attempt escape. In the preferred embodiment, there are not trigger mechanism or door drop mechanisms for the animal to play with, and potentially damage. The double wall construction is extremely rugged, lending itself well to remote field use with long service life. In the case of the traps with dual doors, one at each end, or traps with grating at the back end, the traps appear to be passages. Animals are familiar with culverts under roads, and do not fear entering them. Indeed, in field tests, animals often simply curl up and go to sleep, and do not want to leave the traps, once the doors are opened during retrieval.

Thus, the inventive trap provides a mode of trapping that is very humane, in that it is not a leg or body grip type trap, does not permit the animal injury-promoting escape options, shelters the animal from the elements and heat, visually shelters the bait, visually shelters the trapped animal from predators, and through its communications module, permits prompt retrieval of an un-injured animal.

A convenient, economical material for the tube is commercially available double-walled plastic (polyolefin, ABS or the like) culvert which is strong and relatively cheap. The best mode implementation of the trap uses a single door at one end, an electrically powered trigger system comprising a spring-biased door release, a solenoid-actuated catch, a magnetic trigger system, a battery and associated electrical switches. An alternate electrical embodiment comprises a solenoid-actuated door release, a trigger-plate that actuates a micro-switch trigger, a battery and associated electrical switches including a door-drop kill switch.

In addition, the inventive humane tube-type trap includes several entirely mechanical trigger release systems and door configurations, including a dual door system with one door at each end, and both vertical drop doors and swing-down flap-type doors. Optional elements include an internal electric light, a removable or pivotable top access hatch through which the trap interior or/and trigger plate can be serviced, inspected, cleaned or baited, and optical or infra-red reflectors that become visible when the door is tripped closed.

The inventive trap monitoring and management electronic data communications system includes both trap-mounted or trap-connected components, separate, remote signal relays, monitoring station components, and auxiliary equipment including locators (GPS locators). The home base monitoring station includes a computer system having a CPU in which is loaded data engine and display programs to enable activation and operation of the data system. The trap communication module comprises a programmable Peripheral Interface Controller (PIC), a battery, a transmitter or transceiver (transmitter/receiver), and inputs from the trap switch circuit as well as I/O ports for configuring the programmable PIC by the computer programs and location input from a handheld GPS locator device. The trap comm module can have its own battery supply (with a charger port), or share a battery with the trap trip circuit, or contain in a single battery the power for both the trip circuit and the comm module (preferred).

The remote monitoring aspects of the invention provides a method for trappers to monitor from a single “home” base, many traps simultaneously, the number ranging easily in the hundreds, depending on the geographic extent of the area of trapping. Unlike fishing with a line, a trap placed in a field has no “line” back to the trapper. However, under the inventive system, the trapper can visually and/or audially check when individually located traps are tripped. Thus, the need for checking each trap each morning is not required; each trap is serviced when tripped based on the status alert radioed to home base from each trap when that event occurs.

The inventive monitoring system provides a unique location address for each trap in the field that is radioed to home base when the trap is first set in the ready mode in the field. Each trap is pre-configured at home base via the programs with identification number or other data (name, type, client, etc), and its cycle of time for status reporting is pre-selected at that time. After placement in the field and “set”, the trap reports its status or/and location back to home base on the predetermined time cycle, e.g., every half-hour, more frequently at night, less during the day, etc.). The program at home base displays a map from the map program with each trap located thereon with its unique icon, and the status can be indicated in text or change of icon, e.g., by animating the icon, changing color, flashing, change of text, combinations of them, and the like. In addition, an audio alert signal can be emitted on the computer speakers when the trap is tripped. The inventive computer system permits complete management of the trapping as a business, including communication via the Internet of trapping reports, orders, billing, e-mail communications, and the like. In addition, the status reports of each trap can be printed out for analysis, or computer-analyzed to show catch events related to time of day, season, by year, by location, and the like. The accumulation of trapping data in a region over time can also be analyzed to reveal animal population changes, migration, animal range, and the like.

The inventive communication system includes provision for a wide range of inputs at trap location. That is, the PIC can accept a variety of inputs, including temperature, moisture, wind speed, sound, ambient light, and visual inspection both interior of the trap and external to it, by placement of appropriate sensors that are well known in the art and commercially available. For example, IR and Ultra-sound sensors, microphones, bolometers, thermometers, wind cups, rain gauges, humidity sensors and surveillance optics (some as small as coin sized) are readily available. Following the principles taught herein, one skilled in the art will easily be able to mount any selected sensor(s) and hook them to the PIC for transmission of the sensed data back to home base for display or storage in the computer database. In the embodiment(s) in which a transceiver is mounted on the trap, the home base can selective poll individual sensors for readings, or the PIC can be programmed to provide selected readings on a timed cycle. For example, upon receipt of a trip signal, the trap can be polled to turn on the microphone and/or camera to ascertain the type of animal trapped.

Typically, the RF transmitter sends a data burst lasting less than a second and is only powered when sending; the transceiver is OFF until the programmed PIC sends a wake-up signal (power enable signal) to the transmitter for the transmit burst. The PIC is preferably configured to send a trip signal immediately upon trip event, rather than wait for the next cycle. The PICs of different traps in a given region are preferably configured with different cycle send times so that no two traps send simultaneously to home base. Since the bursts typically last less than a second the theoretical number on a single frequency is 3600 repeated hourly, but typical is every 30 minutes for 1800 total trap capacity. It is also possible to set the trap comm module to repeat the burst in time-spaced intervals, say once each 5 seconds for 3-6 tries, so 1 minute spacings between different trap reports is more typical. The currently preferred RF frequency used is no-license required frequencies of 154.600 MHz±5 kHz (Green Dot), and 154.570 MHz±5 kHz (Blue Dot). However, dedicated licensed frequencies can be obtained for use through an FCC-licensed Frequency Coordinator. Thus, different traps in a given area can communicate by different frequencies, so the real-time monitoring of hundreds of traps simultaneously is entirely feasible under the inventive system.

In one important alternative embodiment, the door is held in its “ready”, un-triggered, raised position by a solenoid pin, or a spring-biased rod having a solenoid catch, that extends through a hole in the door adjacent the bottom of the door. When the trap is tripped, the solenoid pin or rod retracts, the door descends and it engages a switch that opens the circuit, killing power to the solenoid door release latch pin or the rod catch solenoid. The spring biases the solenoid pin or the rod to the extended position, positively latching the door in the closed position through a hole adjacent the top of the door (the “trap sprung” hole). However, there is enough play in the trap sprung hole that a slight lift of the door releases the switch, energizes the solenoid and retracts the pin from the sprung position hole. This permits the door to be raised fully. This function is a safety system in the event a child crawls into the trap. Although an animal cannot raise the closed/lowered “sprung” position door, a human can by engaging a finger in the lower “set” position hole and sliding the door upward. The slight oversize of the “sprung” position hole permits the door to move upward just enough to open the door switch, killing power to the solenoid and releasing the pin. The door can thus be raised easily to permit egress of the child. In addition, the door can be maintained in the lowered, sprung position by actuating an ON-OFF switch provided in the circuit.

In another, preferred alternative, a small, un-obtrusive, tamper-proof light, such as an LED, is provided in the inside roof of the tube to illuminate the animal inside. The animal can be viewed through a peep-hole provided in the middle of the door or through a mesh back. In addition, the peep-hole provides a second finger-hole for lifting the door from the inside, in the case of a trapped child.

The preferred embodiment is a dead-end, single door trap, but a dual door trap having doors at each end is within the scope of this invention. In a particularly useful embodiment of the versions of the inventive trap wherein a communications module is not used, each door includes a reflector that is essentially not visible when the trap is set. The reflector(s) are revealed when the trap is sprung, thus permitting status checking from long distances by the trapper to determine whether a capture has been made. In a first embodiment, the reflectors are mounted on the trap doors, and in the second embodiment the reflectors are preferably reflective tape on the door guide framing assembly, the tape being revealed upon the door dropping when the trap is sprung.

In the preferred embodiment the door slidingly travels vertically in guides. The internal trigger mechanism is preferably a Normally Closed magnetic switch (proximity switch) responsive to a magnet secured to the bottom of a bait can, and no trigger plate is required. In another, no-trigger-plate embodiment, the weight of a bait can depresses an electrical plunger type micro-switch of an NC type mounted through the bottom wall of the tubing. The plunger is spring biased to be extended in the closed (contact) mode at which time it passes current. The weight of the bait presses the plunger down, breaking contact, and the circuit is not energized, conserving battery power. When the bait is moved, the plunger rises, closing the switch and permitting current to flow. The solenoid or latch rod is spring biased in the extended position. Current must be applied to retract the pin. When the current flows, the pin retracts and the door drops. Alternatively, a Normally Open micro-switch can be mounted below a trigger plate, which upon being depressed closes the switch.

The inventive trap is of particular use in the trapping of nocturnal feral wildlife or nuisance domesticated animals that pose problems to communities such as raccoons, coyotes, foxes, feral cats, stray dogs, rabbits, minks, skunks, opossums, otters, beavers, muskrats, badgers, bobcats, lynxes, woodchucks, wolves, nutria, wolverines, and the like, by wildlife and nuisance control agencies and state-authorized trappers. Smaller versions of the trap can be used for control of rats, mice, squirrels, prairie dogs, gophers, and the like.

The principles of the inventive trap can be applied to embodiments having a wide range of diameters and lengths. The door frame includes a flat bottom or cross member, preventing the trap from rolling around its longitudinal axis. By way of example only, a trap having a single door, a mesh back end, an inner diameter of 18″ in diameter, and fitted with a comm module for remote monitoring is described in more detail below.

### BRIEF DESCRIPTION OF THE DRAWINGS

The invention is described in more detail with reference to the drawings in which:

FIG. 1a is an oblique front isometric view of the best mode electrical implementation of the inventive trap having a magnetic trigger sensor and an event data communications module installed;

FIG. 1b is a trigger circuit diagram of the FIG. 1a trap;

FIG. 1c is an isometric view of the front end of the trap of FIG. 1a showing the door release rod mechanism, and partially broken away views of the midsection solenoid-actuated catch and the magnetic proximity sensor at the bottom of the trap;

FIG. 1d is a trigger circuit diagram of a second embodiment of the inventive trap shown in more detail in FIGS. 1e and 1f, in which the door latch is a solenoid;

FIG. 1e is an isometric of the front end of a second embodiment of the inventive trap in which the door latch mechanism is a battery powered solenoid and showing electrical on-off and dill switches;

FIG. 1f is a partial section view of the trigger plate and an NO micro-switch of the trap embodiment of FIG. 1e;

FIG. 2a is an oblique front isometric of a first mechanical embodiment of the inventive trap with a data communications module installed;

FIG. 2b is an exploded schematic of the mechanical trigger and door release system of the FIG. 2a trap embodiment;

FIG. 3 is a side section detail view of the door release rod mechanism of the FIG. 2a trap embodiment;

FIG. 4 is an isometric of the trigger plate and cable of the FIG. 2a trap embodiment;

FIG. 5 is an oblique rear isometric of the inventive traps of FIGS. 1a, 1e and 2a;

FIG. 6 is a schematic front isometric of a third, double door, mechanical embodiment of the inventive trap;

FIG. 7 is a detail of the trigger mechanism of the FIG. 6 trap;

FIG. 8 is a schematic front isometric of a fourth, double pivot door, mechanical embodiment of the inventive trap;

FIG. 9 is a detail of the trigger mechanism of the fourth embodiment of the inventive trap of FIG. 8, showing an access door near the center of the trap for access to the trigger plate;

FIG. 10 is an isometric detail view of the pivoted door of the FIG. 8 trap embodiment;

FIG. 11 is a block diagram of the inventive trap data signal and control module; FIG. 12a is a geographic pictorial elevation drawing of the inventive data communications system in operation;

FIG. 12b is a block diagram of the architecture of the inventive data communications system, showing both the field and the home base component; and

FIG. 13 is a flow chart showing the method of operation of the inventive data communications system.

### DETAILED DESCRIPTION, INCLUDING THE BEST MODE OF CARRYING OUT THE INVENTION

The following detailed description illustrates the invention by way of example, not by way of limitation of the scope, equivalents or principles of the invention. This description will clearly enable one skilled in the art to make and use the invention, and describes several embodiments, adaptations, variations, alternatives and uses of the invention, including what is presently believed to be the best modes of carrying out the invention.

In this regard, the invention is illustrated in the several figures, and is of sufficient complexity that the many parts, interrelationships, and sub-combinations thereof simply cannot be fully illustrated in a single patent-type drawing. For clarity and conciseness, several of the drawings show in schematic, or omit parts that are not essential in that drawing to a description of a particular feature, aspect or principle of the invention being disclosed. Thus, the best mode embodiment of one feature may be shown in one drawing, and the best mode of another feature will be called out in another drawing.

All publications, patents and applications cited in this specification are herein incorporated by reference as if each individual publication, patent, or application had been expressly stated to be incorporated by reference.

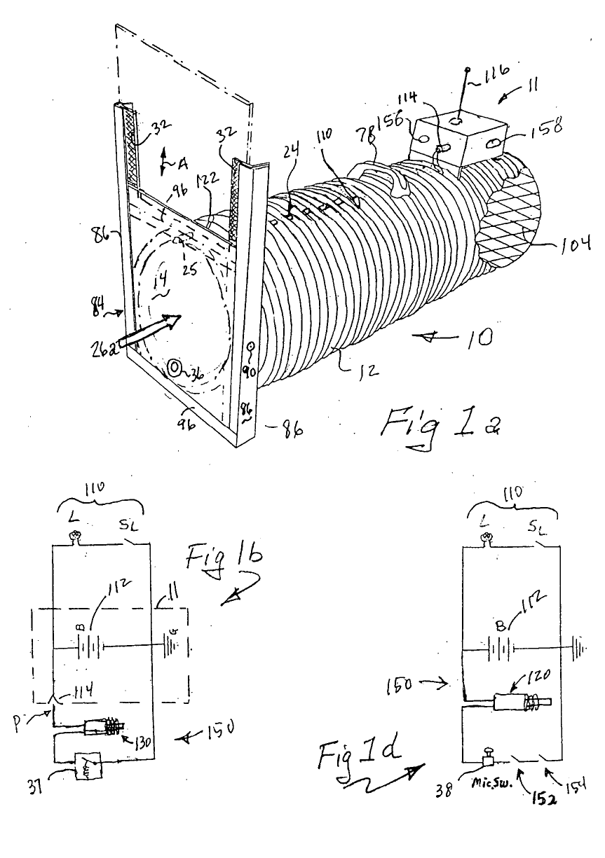

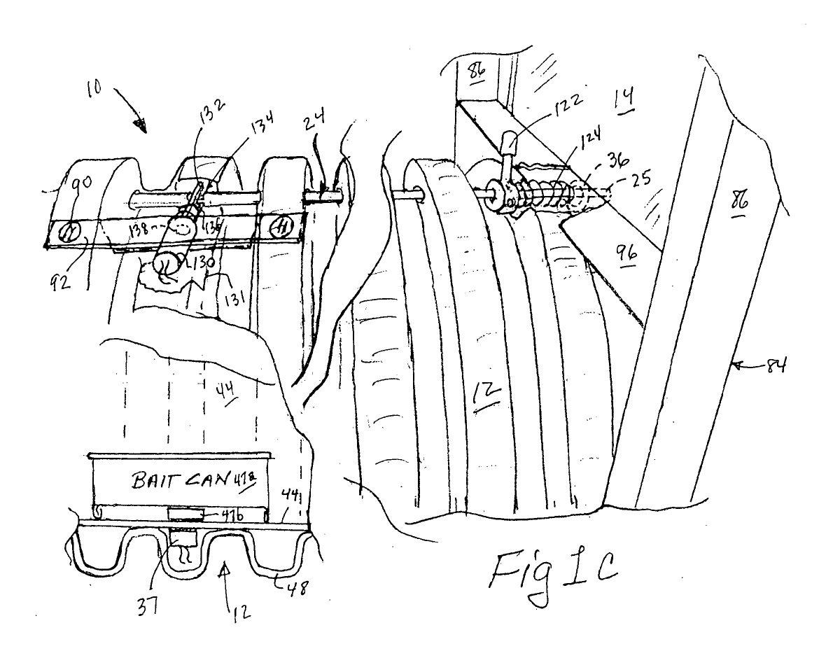

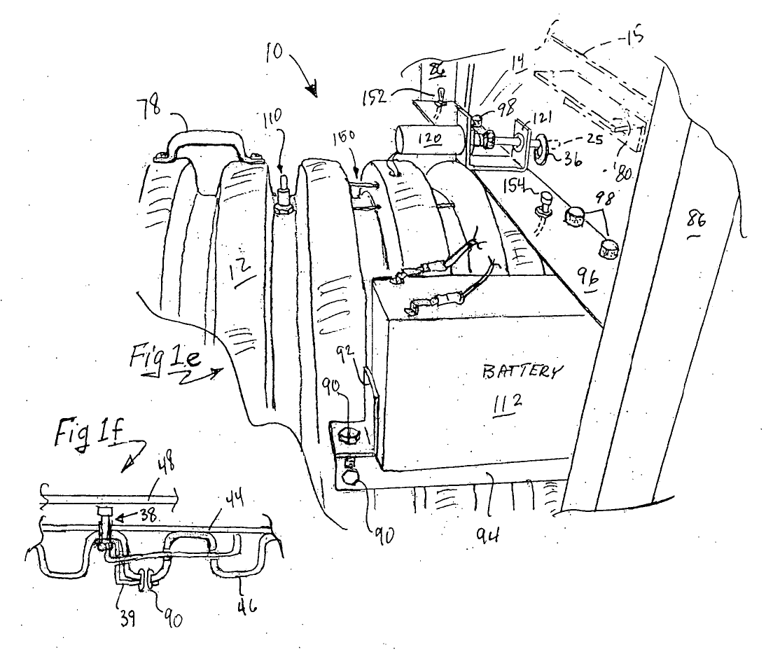

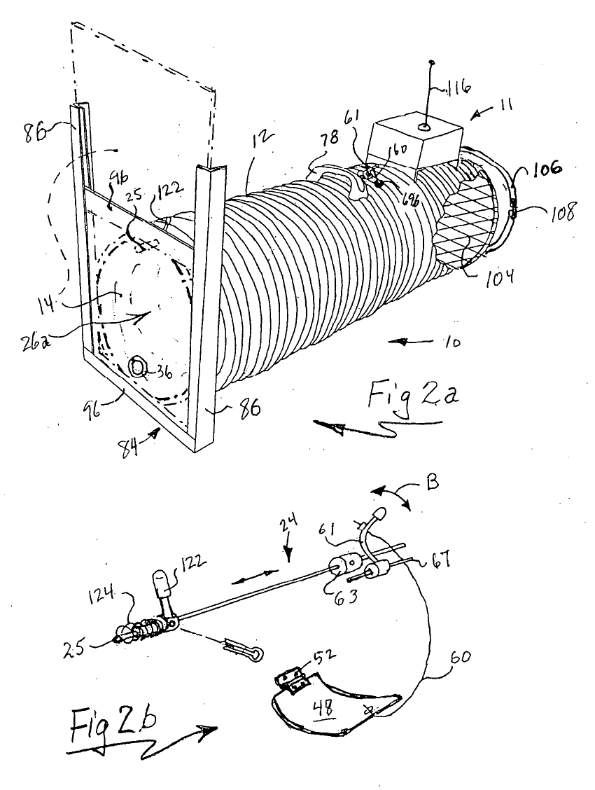

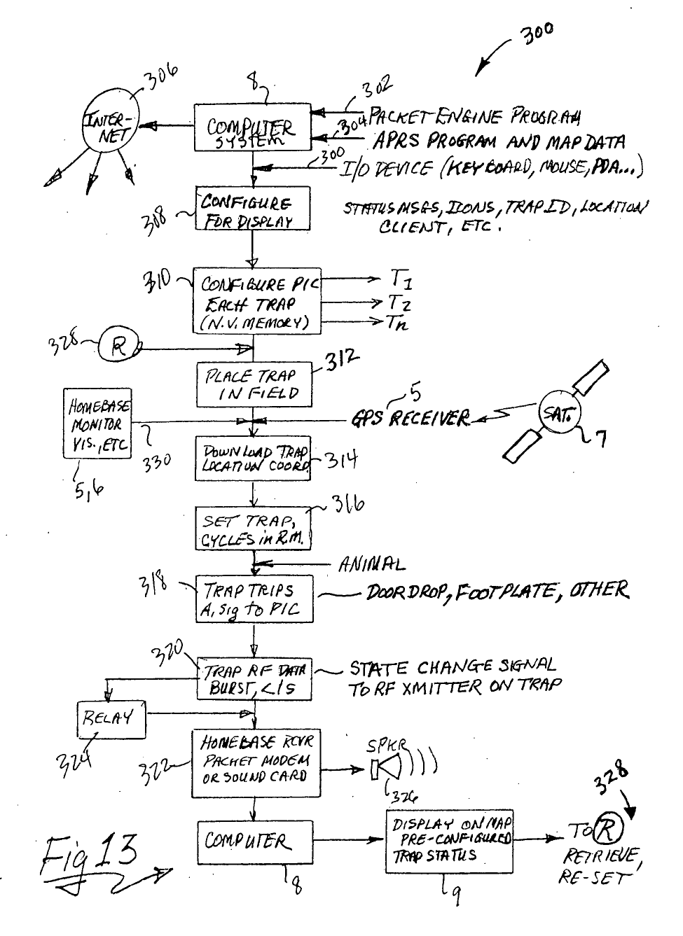

FIGS. 1a, 12a and 12b illustrate the inventive trapping system as comprising trap assembly 10 placed in the field with its communications module 11, repeaters R1, R2 . . . Rn, as needed, communicating by RF signal with a home base 4 that includes a receiver 6 and a computer system 8 that includes a display 9.

In more detail, FIG. 1a shows the present best mode electrically-actuated door-drop embodiment of the trap assembly 10 with a communications module 11 mounted thereon. The comm module can be separate from the trap and is connected to the trap trip circuit 150 (FIGS. 1b and 1d) via plug 114. The comm module is contained in a suitable weather-proof, tamper-proof housing, which includes sealable connector ports 156 for recharging the battery, and a data connector (typically 9-25 pin connector) 158 for download to the module PIC of various configuration data.

The trap body 12 is a double walled tube, preferably heavy duty plastic, approximately four feet long, of a type commercially available and commonly used for culverts. As seen, e.g., in FIG. 1c, the inner wall 44 is smooth and the outer wall 46 is corrugated and seated or sealed (e.g., glued, fused, or thermally or RF welded) tightly against the inner wall. In this implementation the tube inside diameter is approximately twelve inches, but may be larger or smaller as trapping need dictates. As will be seen in FIGS. 1c, 1e, 1f, 2a, 2b and 3, advantage has been taken of the double wall construction to shield various parts of the trap mechanisms and wiring. The FIG. 1a embodiment has a single, guillotine-type vertical drop door 14, as shown by arrow A, that is fabricated from ¼″ thick aluminum plate. The trap entrance 26a is shown in dashed lines behind the door, which in this view is in the lower, or released/tripped, position. A phantom view of the door is shown in the upper, or “trap set” position. The door slides vertically in guide tracks formed by spacing nested vertical aluminum angle members 86; cross members 96 complete the door frame assembly 84. The door release rod mechanism 24 with reset lever 122 is described in more detail with reference to FIG. 1c. In the raised position the tip 25 of the door release rod 24 projects through the hole 36 (which preferably includes a metal or tough plastic wear bushing). One or more handles 78 are positioned at any convenient place on the top or sides of the tube 12 to facilitate handling; where a single one is used, it is preferred to place it at the longitudinal, front-back, balance point. An interior light having an external push button switch 110 may conveniently placed above the medial bait area to facilitate inspection. The rear end of the trap is closed by a mesh 104a or solid end-cap 104b (see also FIG. 5).

The door frame 84 is preferably constructed of aluminum angles or suitably profiled extrusions to provide the slide track. The two door frame uprights 86 are formed by welding two nested, but offset, lengths of the angle aluminum together to leave a slot between the inner face of the outer angle and the outer face of the inner angle to be slightly larger than ¼″ such that the door can easily slide up and down in the slots. The door frame cross bars 96 are also aluminum angle, one fitted at the bottom of the uprights and one at a height determined by the tube outside diameter. The dimension between the uprights, and the length of the cross bars are also determined by the outside diameter of the tube. The door frame is fastened to the trap tube by rivets, screws, bolts or other suitable fasteners, 90, at each of the four tangential points where the doorframe members contact the tube.

FIG. 1a, also shows reflector tape 32 is attached to the vertical door guides 86. When the trap is in the “set” position, the reflector tape 32 is covered from view by the raised trap door(s) 14. When the trap is sprung, the trap doors 14 gravity-drop down guided by the trap door frame assembly 84, revealing the tape 32. When the reflector tape 32 is showing, the trapper knows the trap has sprung. Other systems for detecting a sprung trap may be used as discussed below.

FIGS. 1b and 1c illustrate the trip and door drop mechanism and the trap circuit 150 for this first electrical embodiment. A magnetic proximity switch 37 is secured within one of the corrugations at approximately the longitudinal center, bottom, of the tube 12 where it is shielded from weather and tampering. The wiring, as shown in FIG. 1b threads up the tube corrugation to a catch solenoid 130 mounted in bracket 92 secured near the top of the tube by screws 90. In this embodiment, the bracket spans three corrugations, with the middle one having a cut-out 131 to receive the catch solenoid. The cut-out piece of the corrugation can be replaced once the solenoid is installed through a hole 138 in the angle bracket flange as shown. (The solenoid securing nut and the replaced corrugation piece are not shown due to the scale and perspective of the drawing.) The solenoid plunger has a forked end 132 that engages opposed notches 134 cut in the trip rod 24. The solenoid spring 136 biases the fork into the notches. At the forward end of the trip rod, the tip 25 extends through the grommeted hole 36 of the raised door 14 that is maintained in the tracks of the vertical side rails 86 of the door frame 84. The fork 132 engaging the notches 134 maintains the spring 124 compressed between the vertical face of angle cross-piece 96 and the collar of the reset lever 122.

To set the trap 10, it is placed in a suitable location in the field, the door is raised, and the trip rod is reset with lever 122 pushed to the right until the solenoid fork 132 engages the notches 134. In this position, the rod tip 25 projects slightly, say on the order of ¼″-½″ through the hole 36 of the raised door 14 or below its bottom edge. A bait can 47a having a magnet 47b secured to its bottom is loaded with a suitable bait and placed in position directly over the Normally Closed proximity switch. The magnetic force opens the switch. As seen in FIG. 1c and the circuit of FIG. 1b, when the bait can is disturbed by an animal, the switch 37 closes, the battery powers the catch solenoid 130 to momentarily retract, spring 124 pushes the rod 24 to the left, the rod tip 25 is retracted through the hole 36 and the door drops trapping the animal. The trip pulse also is an input to the comm module circuit (FIG. 11) which initiates sending the RF “trap tripped” signal to home base.

FIG. 1b is the electrical circuit diagram for the FIG. 1a trap trigger system, (a trap with a magnetically actuated trigger). As long as the normally open magnetic proximity switch 37 remains open, the circuit is dormant. When the switch closes, 12 volts of the battery 112 is applied to the catch solenoid 130 (see also FIG. 1c) causing it to retract its solenoid plunger from the notched trigger rod (24 FIG. 1c). The solenoid plunger is normally extended by the force of the spring, but retracts and remains retracted when voltage is applied. When the solenoid is in the fully extended position with the fork in the notch of rod 24, it is in a closed, conductive state. However, the circuit is open due to the open proximity switch 37. When it is energized, and goes to the fully retracted position, it also opens the electrical circuit. That cuts off the current, and the spring again forces it outward. However, the rod notch is now to its left, and the fork cannot fully extend to the closed circuit position. That is, in the partly extended position with the fork tines against the un-notched portion of the rod, the solenoid is still in the open state. Thus there is only momentary current flow when it retracts, and there is no current, or battery drain, after the triggering action. Physically, the battery 112 is preferably located within the trap communications module (FIG. 1a, 11) where it also powers the trap electronics (see FIG. 11). The trigger circuit is activated by inserting plug 114 into the communications module socket. The circuit diagram also shows an internal trap light and its switch 110 which are optional and independent of the trigger circuit.

FIGS. 1d-1f illustrate a second electrically actuated trap embodiment. In this embodiment, the trip rod assembly is replaced with a trip solenoid 120 mounted in a U-bracket 121 secured to the top face of frame cross member 96. As before, the trip rod tip 25 extends through the hole 36 maintaining the trap door 14 in the raised, set position. A battery 112 provides power to the trap circuit 150. A Normally Open micro-switch 38 is installed through a hole in the center, bottom of the trap, with its plunger projecting just above the inner surface 44 of the tube 12. This location is just below the approximate center of a step-on type trigger plate 48 that is pivotally hinged to one side of the interior of the tube (see, e.g., FIG. 2b or 4). The trigger plate is baited.

The circuit is powered by a 12 volt battery 112 dedicated to this circuit. Switch 152 is an On-Off switch that is turned on as the first step in activating the trigger circuit. Switch 154 is a normally closed kill switch, and is operated by the position of the door. When the trap is “set”, the door is up (trap open, or set), the switch 154 is closed and the trigger circuit is fully activated. When the trap is triggered, the door falls and opens the kill switch 154. When switch 152 is On (closed) and the trap is set (switch 154 closed) the circuit is controlled by the N.O. micro-switch 38.

When the animal steps on the plate, it is depressed, contacting and closing the switch, momentarily energizing the solenoid 120 which retracts its plunger and the door drops to the tripped position. As before, the pulse activates the comm module to send the trip signal to home base. As an alternative in this embodiment, the micro-switch can be a Normally Closed type and the step-on trigger plate eliminated. A weighted bait can is placed over the switch button, holding it down in the “Open” state. When the bait can is disturbed, the internal spring of the switch pops the button up, the switch goes to the “Closed” state, triggering the solenoid to retract, dropping the door. Note that this circuit includes an “ON/OFF” toggle switch 152 and a Normally Closed “Kill” microswitch 154. A piece of angle 80 is secured adjacent the upper edge of the door 15. When the door drops, the horizontal flange of the angle depresses the switch button 154 opening the circuit so that the solenoid no longer draws power to deplete the battery. Thus there is no current in the circuit, therefore no battery drain while the trap is set, momentary current when the trap is triggered, and no current after the trap is tripped.

In this embodiment, the battery 112 for the trap circuit 150 is separate from the comm module, mounted on bracket 94 and secured in place with flange 92. The wiring is not shown in its entirety in FIGS. 1e and 1f; for wiring, one skilled in the art can follow the FIG. 1d circuit diagram, which is strait-forward. Also, due to the scale of the drawing, the angle 80 is not shown in proper position relative to the micro-switch 154; in practice it is approximately a foot above the switch. The rubber bumpers 98 cushion the fall of the angle and reduce the contact noise so the animal is not frightened.

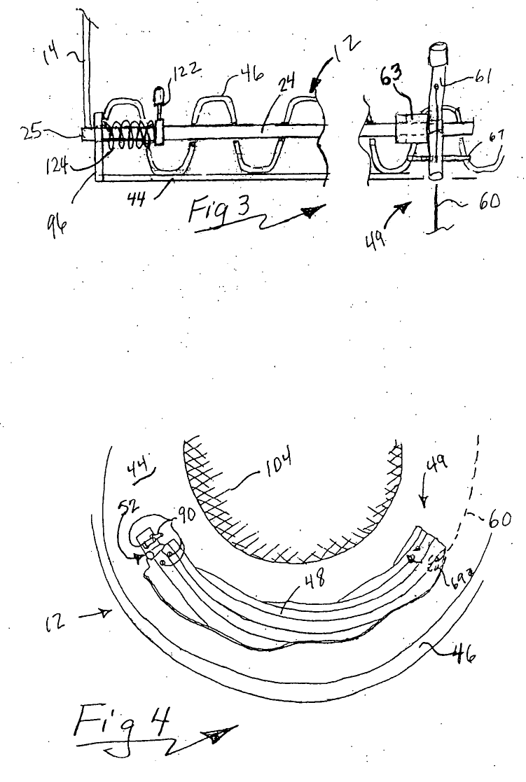

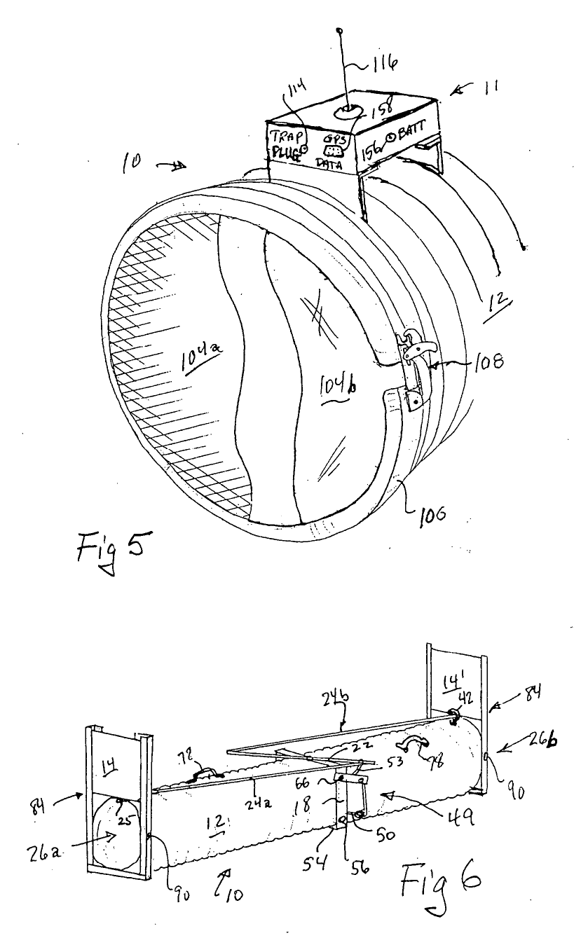

FIGS. 2a, 2b, 3 and 4 show a third embodiment, being the best mode mechanical, non-electric implementation of the inventive trap. The handle 78 is mounted to the trap near the balance point to facilitate handling. A trigger release lever 61 is shown just beyond the handle toward the rear. The electronics case 11 and antenna 116 is mounted on the top of the tube at the rear. Steel mesh 104 is fitted to the rear of the trap at the end opposite the door 14. The mesh is held in place by a ring collar 106 and clamp 108. The collar is fabricated by cutting one corrugation ring from a tube of the type being used for fabrication of the trap, removing the inner wall and cutting the ring at one point. This makes a circular ring that can be stretched open and fitted over the last corrugation of the trap and the steel mesh held tightly against the end of the trap. The clamp 108 (better seen in FIG. 5) is attached by screws to the clamp ring and used to tighten the ring thereby holding the mesh firmly in place. The door and frame parts are as above-described. The reset lever 122 is seen at the forward end, and is connected by the trip rod 24 that passes through corrugations as best seen in FIG. 3. The trigger plate and cable is illustrated in FIGS. 2b and 4.

FIG. 2b shows an exploded schematic of the door release system and FIG. 3 shows the trip rod assembly in sectional elevation as mounted in the top of the tube 12. (The left end of the drawing is at the front, or door end, of the trap). The reset lever 122 is a short length of rod welded to a round collar, slipped over the trip rod 24 and fastened to it by a cotter pin. In setting the trap, the trap door (not shown) is lifted, the trip rod reset lever is moved toward the front of the trap to the position that the door can be rested on the tip 25 of the rod 24, or the tip passed through hole 36 in the door 14. This movement compresses the trip rod biasing spring 124. The trip rod release lever 61 is then rotated counterclockwise to a position contacting the trigger rod release collar 63, and holding it in the “cocked” position. The release lever is bent in a generally L-shape as its pivot rod 67 is offset to clear the collar 63. The trigger plate 48 (also seen in FIG. 4) is inside the trap tube, fastened by a hinge 52 to one side at a height that leaves the opposite end free-floating. The trigger plate is fabricated from a section of tube corrugation cut on the bias, or from any rigid, rounded sheet material. The trigger wire 60 is secured to the floating end of the trigger plate and passes through a hole 69a in the inner wall 44 of the tube 12 and is threaded up a hollow corrugation to exit hole 69b and is secured to the upper end of lever 61. The trigger plate is baited and when downward pressure is applied to the plate, as by an animal, the trigger wire 60 is pulled downward by the end of the plate where it is attached. The pull on the wire 60 causes the trigger release lever 61 to rotate clockwise to the right, Arrow B, releasing its contact with the trip rod release collar 63, removing restraint from the compressed trip spring 124 which pushes the trip rod 24 to the right retracting the rod tip 25 and the door 14 falls, closing the trap.

FIG. 5 is an isometric of the opposite end of trap 10 illustrating that the end can be closed by wire mesh 104a or sold sheet metal or plastic plate 104b, held in place with collar 106 by an over-center type clamp 108. In the case of the mechanical trigger and release mechanism embodiments of FIGS. 2a through FIG. 10, the trap need not but may have a communications module 11. The RF signal is triggered by one or more sensors mounted in the trap which are plugged into the comm module 11 via plug 114. These sensors are powered from the module; for example the light 110 can be replaced with a US transducer to detect motion in the trap, or the motion of the release lever can actuate a micro-switch or a magnetic proximity switch located adjacent to the lever. Those switches have been disclosed above.

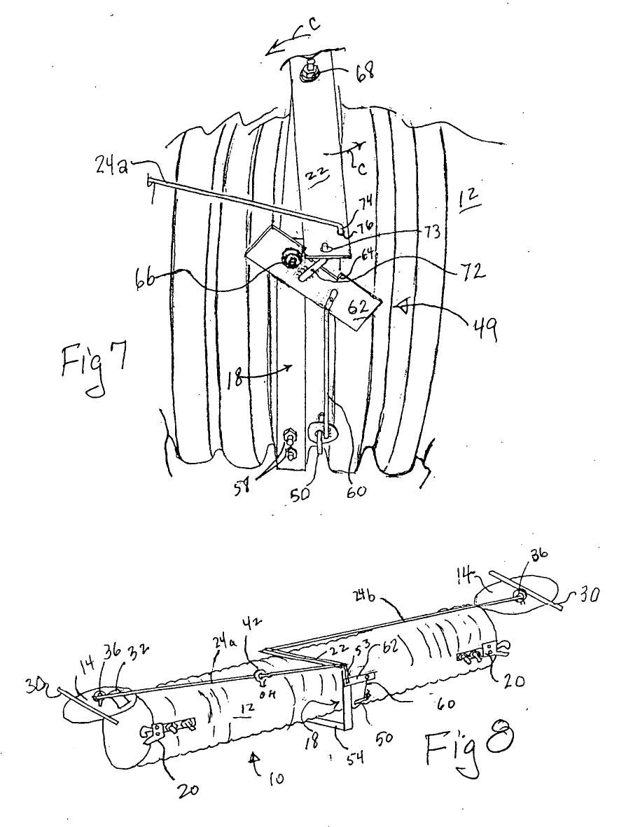

FIGS. 6 and 7 illustrate a first, and FIGS. 8, 9 and 10 illustrate a second, external, mechanical trigger system, as embodiments four and five of the inventive trap assembly. These embodiments are particularly useful in cases of nuisance trapping in very local areas, such as small towns, private property, golf courses, parks and the like, where RF monitoring is not required or economically feasible.

FIGS. 6 and 7 illustrate the inventive features in a second external mechanical embodiment having vertically sliding trap doors and rod trigger linkage. This embodiment is also axially about the same length as the electrical embodiment of FIGS. 1a and 2a.

Referring to FIG. 6, this embodiment of the tubular trap 10 comprises a double-walled tube (plastic or metal culvert) 18 inches in diameter (as compared to the 12 inch diameter of the tube in the first three embodiments above), with a length of approximately 5 feet. The 18″ diameter tube 12 more closely matches the diameter of culverts found in urban settings, and the vertically sliding trap doors 14, 14′ allow the tubular trap to be positioned flush with the openings of existing culverts to increase the effectiveness of the trap. The diameter of the culvert material used in the trap may be any size sufficient for the size of the desired trapped animal and may be chosen to configure with an existing culvert size in the area. Trigger mechanism 49 is located medially along the tube axis.

A shorter tube length has several advantages. With a shorter tube, it takes less time for the animal to reach the center of the trap and step on the trigger plate, setting into motion the sequence of events culminating in the simultaneous closure of the trap doors at each end of the tube. As a result, there is a quicker release of the trap doors enclosing the animal inside, thereby preventing chasing predators from also entering the trap. A shorter tube also is easier to fit inside truck beds for transportation of the trap, is lighter and easier to carry, and allows for placement and maneuvering of the trap into tighter spaces. As shown, two handles 78 are attached to the tube 12 for carrying the trap into and out of the field. Two handles can be used on each side. Alternately, wheels may be permanently or removably attached to one end of the trap assembly 10 for transport of the assembly 10 by lifting one end and rolling the trap on the wheels.

As shown in FIG. 6, this embodiment of the tubular trap comprises door frame assemblies 84 attached by a bolt 90 on each side to tube 12. The door frame assemblies are disposed at the opposite end openings 26a/b of the tube 12 and include two spaced vertical door guides 86 extending above the tube 12 as described above. The trap doors 14 shown are square, but could be any shape (such as round) sufficient to cover the tube entries 26a/b when the trap is “sprung.” Alternately, one trap entry could be permanently or removably blocked/closed. The doors are of galvanized sheet metal or aluminum. The aluminum can be anodized any preferred color, black, brown, khaki, tan, green, etc. Any material suitable for outdoor use can be used including plastic, wood, metal and combinations thereof.

FIG. 6 is an isometric, schematic view of the trigger linkage and trip rods. FIG. 7 shows a close-up of the trigger linkage, just after the trap has been tripped, or before it is set. The trigger linkage 49 includes a trigger lever 50 extending through a slot in the side of the tube 12 and a trigger mount frame 18. Instead of a wire, the linkage 60 to the trigger release plate 62 is preferred in this embodiment to be a solid rod linkage. The trigger release plate 62 includes a catch notch 64 (best seen in FIG. 7) and an actuator rod 72. The trip rods 24 are assembled to a pivot plate and extend along the body of the tube 12 from pivot plate 22 through a hole in respective rod guide eyes 42 to set the trap door 14 by engagement with a set hole 36 near the bottom of the trap door 14, or the door is supported on top of the rods 24a, 24b near their tips 25. The respective trip rods 24 are linked to the pivot plate 22 by tangs 74 dropped in holes 76 in the ends of the plate 22.

As shown in FIGS. 6 and 7, to set the trap, the trap door 14 is raised manually, guided and held by the vertical guides 86. The trip rod 24 is manually inserted through the rod guide 42 and the bottom of the trap door 14 is rested on the rod, or it is passed through hole 36 (not shown, but see FIGS. 1a and 1c). The trip rod 24 is then slid back so the tang 74 drops in hole 76 in the pivot bar 22, and the catch 64 engages one edge of the pivot bar 22 as seen in FIG. 7. Note in FIG. 7 the actuator rod 72 is curved and inserted in hole 73 in the pivot plate 22. The release plate 62 pivots on bolt 66.

When the animal steps on the trigger plate 48 (see FIG. 4), the free side of the trigger plate 48 moves down, causing the rod 50 to move down. Referring to FIGS. 6 and 7, when rod 50 moves down, it pulls down on the rod link 60, causing the release plate 62 to pivot clockwise on the pivot 66. In turn, the actuator rod 72, engaged in hole 73, causes the pivot plate 22 to rotate on pivot 68 (Arrows C in FIG. 7). The motion (C in FIG. 7) of the pivot plate withdraws the rod 24 out of the set hole 36 or from under the door, and the trap door 14 slides downward guided by the vertical guides 86 covering the trap entries 26a/b. Since the pivot plate 22 withdraws both rods 24 simultaneously (arrows C in FIG. 7), both doors drop simultaneously and the animal is trapped in the tube.

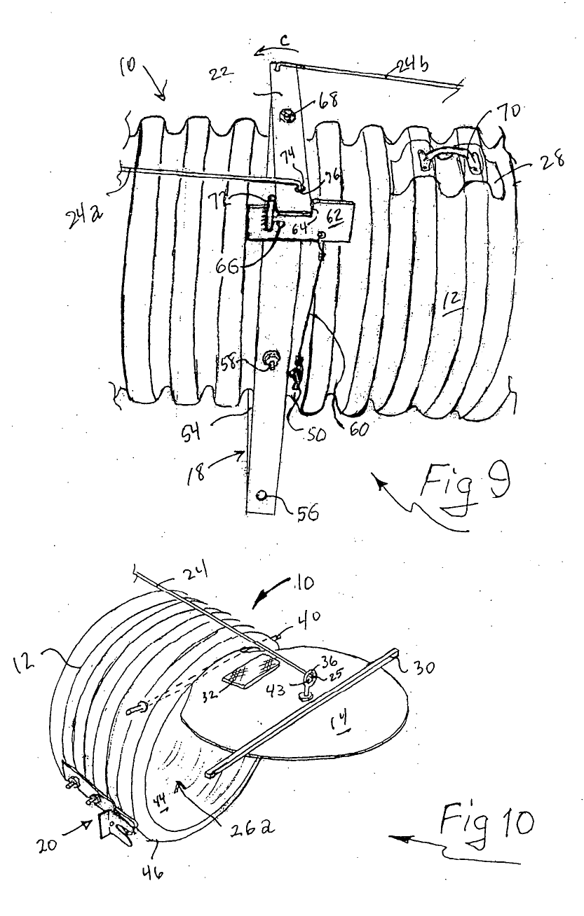

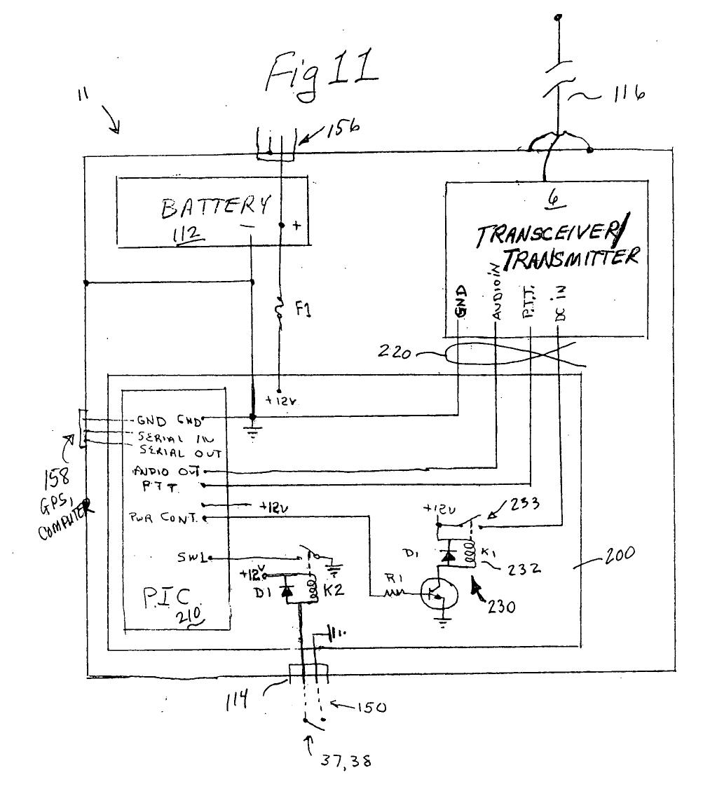

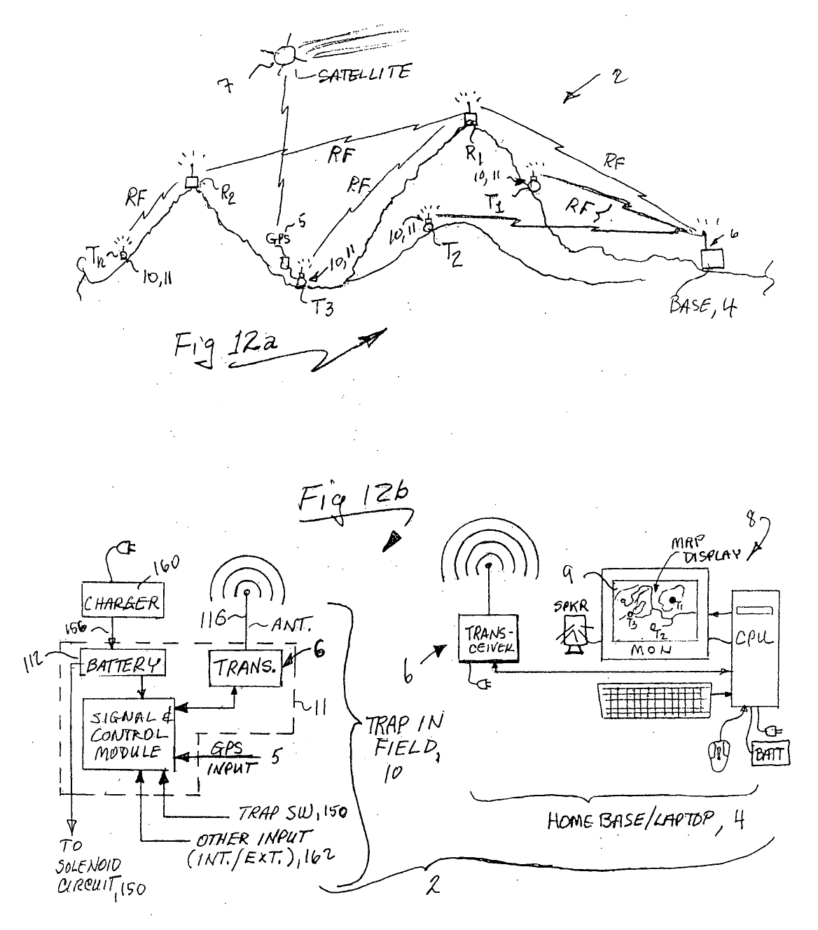

FIGS. 8-10 illustrate a second mechanical trip and door release mechanism in which the doors are flap-type, hinged at the top to pivot closed. Referring particularly to FIGS. 8 and 10, for operation, the trap is set by raising each door manually and its respective trip rod 24 is inserted in the trip eye 36 and slid back so the tang 74 drops in hole 76 in the pivot bar 22, and the catch 64 engages one edge of the pivot bar 22. This is repeated for the second door. As seen in FIG. 7, the trap has just been set. FIG. 10 shows the door raised on it pivot rod 40, the tip 25 of the trip rod 24 passing through the hole 43 in the trip eye 36. When the door 14 drops, the latch rod 30 on the door engages the catches 20 on each side of the tube. The reflector is visible from a distance when the trap is tripped, but not in the set position of FIG. 10, so the trapper can monitor the trap visually from a distance, and at night by shining a light at the trap and observing, with binoculars if necessary.

When the animal steps on the trigger plate 48 (FIG. 4), the free end moves down, causing the rod 50 to move down, pulling on cable 60, causing the release plate 62 to pivot clockwise on the pivot 66. In turn the actuator rod 72 causes the pivot plate 22 to turn on pivot 68 as indicated by Arrow C. The motion of the pivot plate 22 withdraws the rod 24 out of the eye 36 (see FIG. 10), and the trap door 14 closes the tube opening 26. Since the pivot plate 22 withdraws both rods 24 simultaneously, both doors drop and the animal is now trapped in the tube. The tube is long enough so that the animal does not have time to escape while the doors are swinging down into place. The latch rods 30 on each door 14 are lockingly engaged in the latches 20 as best seen in FIG. 10. Thus, the animal cannot push the door open from the inside. Note the latches include holes for a padlock that prevents the latch from being opened inadvertently during subsequent retrieval of the trap with an animal inside, e.g., for catch in an urban area, transport to a wild area and released.

These mechanical linkage traps of FIGS. 6-10 can also be used with a communications module, either mounted on and linked to the mechanical trip mechanism as described above, or linked to a comm module placed adjacent to the trap and linked to it via port 114 by a suitable data or signal cable.

FIG. 11 is an exemplary schematic of the communications module circuitry employing a configurable communications module 11 which is shown installed at the rear of the traps shown in FIGS. 1a, 2a and 5. This exemplary embodiment of the trap communications module can be used with all types of traps, not just the embodiments of the humane, opaque tube traps of this invention having “all electric” trigger systems or “all mechanical” trigger mechanisms. The trap communications module is adaptable to any trap by attaching a switch closure device to the trap in a manner to cause the switch to close when the trap is tripped.

A principle purpose of the communications module is to enable monitoring of trap condition, “set” or “triggered”, with transmission of the information to the home base monitoring system (see FIGS. 12a, 12b and 13). The trap communications system can accommodate a large number of traps spread over a large geographic area (see FIG. 12a).

The communications module is easily installed and removed from a trap. A reserve inventory of the modules is preferably maintained at home base with batteries charged ready for installation. At the time a trap is readied for placement in the field. The module is connected to the base station computer through its serial data port to encode the appropriate data, such as trap number, date, time period between repeat messages, etc. The traps with modules are then taken to the field location where they are to be used for trapping. After suitable trap placement location is determined, a handheld GPS receiver is used to receive position data from a GPS satellite, and that data is fed into the same serial data port that received the computer data at home base. Preparation of the trap is then completed by loading the bait, opening the door and setting the trigger mechanism.

Continuing with FIG. 11, the communications module 11 comprises a 12 volt battery 112 as the power source, an interface board 200, a programmable peripheral interface controller module (such as a PIC 16F628-20/p) 210, containing a pre-installed transceiver control program, that has been configured with communications firmware, such as TinyTrak3 brand real-time tracking firmware from Byonics Inc., of Las Vegas, Nev., and the necessary connector points from these to related and auxiliary equipment such as the Ground Position System/Computer data connector plug 158, the transceiver/transmitter connectors 220, and the trap circuit 150 with trip event switch 37, 38.

The battery is connected to the interface board 200 with negative terminal grounded. 12 volts provided to the peripheral interface controller 210. The circuit on the interface board, comprising the transistor, R1, D1, and K1 is a powered switch 230, normally open. The purpose of the switch is to energize the transceiver (shown as element 6 in FIG. 12b) when a communicable event occurs, such as the trap being tripped or the trap being polled for other sensor data. The trap circuit 150 is energized when the trap is tripped providing a “switch closure” signal to the PIC 210 . The PIC in turn provides a voltage to the transistor, biasing it so current flows. This current is through the relay coil 232 causing the switch contacts 233 to close. Closure of the switch provides 12 volts to the transmitter/transceiver. Thus the transceiver is normally not powered, but is activated in a few seconds only whenever an activating event occurs, such as the trap is triggered.

Once the trap is tripped the communications module will transmit messages only at the time interval previously selected and configured into the PIC 210, or upon a trip or other selected event. The system operator detects the data as displayed on his computer screen 9. Alternate embodiments include provision for environmental, visual and activity data sensors at the trap site, such as animal presence, motion, temperature, wind velocity and direction, precipitation, etc. A receiver at the trap can be interrogated (polled) from home base requesting reports of available data.

The trap communications system PIC 210 is, by way of example, conveniently implemented through use of TinyTrak3, a small inexpensive radio controller designed to receive into memory and upon a trigger event or cyclic time schedule, broadcast GPS position and event reports. The PIC eliminates the need for a full terminal node controller. When combined with an NMEA00183 GPS compatible receiver, and a radio transmitter in the trap communications module, the PIC 210 will key the radio at user defined intervals, and transmit the GPS location coordinates and the event data. The trap position and status data can be sent as text, and can include position, other data and a time stamp. The PIC can conserve radio battery use by turning the radio on just before a transmission will be sent, and can be configured to transmit a ⅓ second position burst after trap data input, or to send trap data on command from home base or at cyclic intervals. The PIC operating parameters are stored in its internal EEPROM that is configured from computer system 8 at home base 4, and will persist even when power is removed.

FIGS. 12a, 12b and 13 illustrate the system operation employing the inventive traps disclosed that employ a communication module. In the system computer enabled method and Internet enabled business method aspects, a computer system 8 includes a CPU, various peripheral I/O devices 300 such as a keyboard, a mouse, a speaker and a monitor 9. The computer system is powered by AC or in the case of a laptop or PDA, by a suitable battery. The computer system 8 at home base (or a portable, such as a laptop or PDA) is loaded with suitable operating system, applications programs, Internet browser(s), image transfer and e-mail programs. In addition, a packet engine program 302 and an APRS program with map data 304 are employed to decode the RF transmission from the field traps, 10, 11 and to display the location, identification and status of each trap, as well as set the parameters for reporting the trap status on a timed cycle. A suitable software-only packet engine is the AGWPE program available as shareware (for a contribution license fee) from www. raag.org/sv2agw/pepro.htm, which permits receipt of the data from the receiver 6 directly into the sound card of the computer. Alternatively, a packet modem can be used to convert the receiver 6 signal to digital data for input to the serial port of the computer system 8. The AGW Sound Card portion of the AGWPE program permits tuning the audio signal, permitting setting of the volume and squelch of the input signal from receiver 6.

A suitable display driver for the map display feature of the inventive system is an APRS application program, available from www.winaprs.org. These programs are available in Windows, Mac and Linux operating systems, as WinAPRS, MacAPRS and XAPRS, respectively. These two programs function as the interface that takes the data from the sound card or the packet modem into the packet engine and the APRS places the trap location/status data on the map program.

Any suitable map data that interfaces with (becomes embedded in) the selected APRS program is used to provide map images. Suitable sources of map data includes: Tiger Maps, which is Census Bureau map data available from www.census.gov/geo/tiger/. Other sources are US Geological Survey, NASA, Delorme maps, Microsoft MapPoint and Microsoft Streets and Trips.

In addition, the computer system can be configured to communicate via the Internet 306 selected data for operation of the trapping system as an Internet enabled business. This includes reports, communications and billings to remote clients or associates, franchisees, regulatory agencies and the like. It permits a central home office to communicate with regional offices or remote trapping stations manned by trappers in the wilderness. Local or regional “views” of trapping activity, such as the real time trap “trip” events, can be communicated automatically to the remote home offices, permitting a nation-wide management operation.

In step one of the operation, the packet engine and map programs, after being loaded, are configured 308 for display of a selected number of different traps to be monitored by the particular home base, including trap status messages, icons for trap locations or types or status icons as described above, trap ID, trap locations, client, and the like. This configuring steps adjusts the display on the monitor 9 to show the selected geographic region, typically in plan view with contours, water courses, lakes, shorelines and/or roads and other structures, with icons that appear in the correct coordinates once the traps are placed in the field and they report in with their GPS location that is mapped to the coordinates of the map display program. It also configures the trap icons with selections from a menu of operator choices, such as icon type, color, status message (e.g., “set” or “ready” or “tripped” or “sprung”), the time, and any animation or color changes upon the trap trip event that occurs. It also configures a log of the status reports and event times. These are just exemplary configurable features; one skilled in the art will recognize that a wide range of useful configurable and selectable features and management reports can be offered within the scope of this invention.

Then, the PIC controller 11 of each trap, T1, T2 . . . Tn, is configured 310 at the home base. Alternately, this can be done in transit to the field or in the field itself via a PDA. The trap module 11 includes a data port 158 (which may be the same or different from the trap circuit plug-in port 114), that is connected via a serial port to the computer CPU. The non-volatile memory of the PIC (e.g., Tiny Track) is configured for a primary signal, representing “trap ready”, and a secondary signal “trap tripped” to be sent to the transmitter 6 of the trap module 11. The PIC is configured to receive GPS location data and transmit that as well as a trap ID number, icon, and other information selected from a menu of configuration options.

The traps are placed in the field 312, and a hand-held GPS locator 5 that receives position coordinate data from a Satellite 7 is hooked to the trap module 11 via the port 158. The respective trap location coordinates are downloaded 314 into the PIC controller of each trap sequentially, and the trap circuit 150 is plugged into the module 11 via connector 114. The trap is set by lifting the door and baiting the trap 316. Upon the plug in and detecting the trap circuit in set mode, the PIC signals the transmitter 6 of the module to begin broadcasting, at the preconfigured cycle times, the trap status as “Ready Mode”.

When an animal trips the trap 318, the analog signal from the trap circuit goes to the PIC sends a state change signal to the RF transmitter 6 on the trap. In turn it emits an RF data burst 320, either directly to home base receiver/transceiver 322, or via a RF signal repeater 324. As described above, the home base receiver 6 forwards the data signal to the computer 8 directly or via packet modem. The system can be configured to give an audio alert 326.

Upon receipt of the alert, via audio or display change, the trapper initiates retrieval of the trapped animal and resetting of the particular trap, 328. In addition, as described above, the home base can monitor the trap for other sensed conditions, 330. Thus, with appropriate sensors, the particular kind of animal trapped, current trap-locus conditions, etc., can be determined remotely, e.g., with a microphone or CCD camera, the interior of the trap can be inspected or listened to.

Industrial Applicability:

It is clear that the inventive tubular trap of this application has wide applicability to the animal management and control industry, namely to non-injuriously and humanely trap wild and nuisance animals. The inventive trap and method of tunnel trapping clearly is useful to trappers and licensed animal control specialists. It can be easily made of off-the-shelf components, e.g., standard 12″ diameter double-walled plastic culvert, gate latches, 8-12 gauge steel sheet for the doors, aluminum or mild steel the frame components, standard electrical and electronic components and commercially available programs. The inventive trap component is simple to construct, easy to set, provides multiple set modes (burrow and through-passage modes), is easy to clean, is light weight and is easy for one person to handle. Thus the inventive tubular trap has the clear potential of becoming adopted as the new standard for apparatus and methods of non-injurious and humane trapping.

The electrical triggering and electronic monitoring and reporting features permit trapping to come into the modern age, permitting monitoring of a great number of humane traps in essentially real time and prompt retrieval of the animals. It provides an opportunity to develop as a valuable research and real-time statistical data-base development tool for better wildlife management.

It should be understood that various modifications within the scope of this invention can be made by one of ordinary skill in the art without departing from the spirit thereof and without undue experimentation. For example, the trigger mechanism and linkage can have a wide range of designs to provide the functionalities disclosed herein. Likewise the tube may be smaller or larger in diameter than described in detail herein in order to trap any size animal desired. This invention is therefore to be defined by the scope of the appended claims as broadly as the prior art will permit, and in view of the specification if need be, including a full range of current and future equivalents thereof.

1) A humane animal trap comprising: an opaque, substantially sold tubular body having a longitudinal length and a first and a second end, a closable door disposed in association with at least one end, a door drop mechanism, a baitable trigger disposed substantially medial of the length, and said second end is terminated by mechanism selected from a second door, a solid closure and a grate type closure.

2) A humane animal trap as in claim 1 wherein said door drop mechanism is electrically actuated and includes a trigger selected from a magnetic proximity sensor, a micro-switch, and a trigger plate linked to a door drop actuator mechanism.

3) A humane animal trap as in claim 1 which includes an electronic trap data communications module having an RF signal transmitter and power source mounted in association with said trap, said module being activated to send an RF signal to a remote receiver representative of a trap trip event by at least one of drop of said door and trigger disturbance.

4) A humane animal trap as in claim 3 wherein said trap data communications module includes a memory unit and circuit for receiving a download of GPS location data, and said RF signal includes data representative of at least one of said trap location in the field and unique trap identifier.

5) A humane animal trap as in claim 4 wherein said trap data communications module is configurable to send status reports on its condition, selected from at least one of“set”, untripped, or “sprung”, tripped, at pre-selected intervals.

6) A humane animal trap as in claim 5 wherein said trap includes at least one sensor selected from a weather sensor, a microphone, an optical sensor, an ultrasound sensor, and an infrared sensor.

7) A humane animal trap as in claim 6 wherein said trap data communications module transmitter is a transceiver, and said circuit is remotely pollable to report data from at least one of said sensors.

8) A humane animal trap as in claim 1 wherein said tube ranges in diameter from about 6″ to about 24′, said trap body is a double walled tube, said door is a vertical drop door, said trigger is selected from a proximity switch and a micro-switch, and said door drop mechanism includes a solenoid assembly selected from a trip solenoid and a catch solenoid.

9) A multiple trap management system comprising in operative combination: a plurality of traps positioned in the field; a data communications module associated with and electrically connected to said trap to receive a trip signal from said trap, said communications module including configurable trap ID and position locator controller and an interface board for activating a transmitter; an RF transmitter; a remote receiver disposed in association with a base station, and a computer system in communication with said base station, said computer system including packet engine and map data display software for receiving signals of said trap events via said transmitter and receiver, and a display device for display of map data having overlain thereon substantially real-time trap location and status data updates.

10) Multiple trap management system as in claim 9 wherein said trap communications module includes a controller into which GPS position data is down-loadable in the field, and which is configured to report trap status trip events in substantially real time and trap status cyclically.

11) Multiple trap management system as in claim 10 wherein said computer system includes Internet connection capability to report operations to remotely located observers.

12) Multiple trap management system as in claim 10 wherein said trap-associated RF transmitter is a transceiver, said trap includes at least one sensor selected from audio, video, weather, motion or heat sensors, and said controller and said computer are configured so that said trap is remotely pollable to receive at said remote base station inputs from said sensors associated with said trap.

13) Method of management of multiple traps in the field comprising the steps of:
a) providing a plurality of traps, each having a data communications module for transmitting trap location and a trap status event signal to a remote station;
b) configuring said data communication module of each trap with unique trap identification data and broadcast parameters;
c) downloading to each said trap data communication module the unique location of said trap upon positioning in the field;
d) automatically broadcasting from said trap a trap status report selected from a substantially real-time trip event and cyclic timed broadcast of status; and
e) receiving and displaying at a remote location the trap trip event and trap identification data.

14) Method as in claim 13 which includes the step of configuring a computer system with map data of the area in which the traps are positioned, with trap identification display information, and with trap status and trip event information.

15) Method as in claim 14 which includes the steps of providing sensors in association with said trap selected from audio, video, weather condition, motion and heat sensors; polling said trap from said base station to receive inputs from said sensors.

16) Method as in claim 13 which includes the step of enabling operation via the Internet.
